(19) United States
(12) Patent Application Publication
(10) Pub. No.: US 2002/0157914 A1
(43) Pub. Date: Oct. 31, 2002

(54) Method for idle rattle abatement

(76) Inventor: Michael L. Bassett, Auburn, IN (US)

Correspondence Address: Mitchell M. Musial II, Eaton Corporation, 26201 Northwestern Hwy., P.O. Box 766, Southfield, MI, 48037, US

(21) Appl. No.: 09/843,351

(22) Filed: Apr. 26, 2001

(51) Int. Cl. F16D 7/00

(52) U.S. Cl. 192/30 V; 192/113.34

(57) ABSTRACT

Provided herein is a control system/method to abate idle rattle in a vehicle transmission system. Damping is initiated on the basis of sensed transmission engagement state and engine output shaft rotational speed. A wet clutch is controlled to provide damping to torque fluctuations experienced by a transmission input shaft.

### FIELD OF THE INVENTION

The present invention relates to a torsional vibration damping system, more specifically, the invention relates to a torsional vibration damping system for damping idle rattle in a vehicle transmission driven by an internal combustion engine, such as a piston engine.

### BACKGROUND OF THE INVENTION

Torsional vibrations are the rotational irregularities of a rotationally driven component. In a vehicle drivetrain, torsional vibrations are caused by the forces generated within a combustion engine by the combustion of gases during the periodic combustion process. Torsional vibrations of the second or third order which originate from the engine, as a result of the ignition frequency of four or six cylinder engines, respectively, are predominant in the vehicle driveline. Torsional vibrations not only emanate from the engine power pulses but also from torque spikes and from abrupt changes in driveline torque due to rapid engine acceleration and deceleration.

Torsional vibrations cause premature wear to driveline components as well as audible noise. In a conventional driveline, the flywheel, which is rigidly connected to the crankshaft, will generate high reaction forces on the crankshaft. Furthermore, torque irregularities from a periodic combustion engine adds additional stress in the form of high frequency torques to the transmission. Furthermore, when a manual transmission is in neutral, gear rattle occurs, which is also an audible event, due to the teeth of meshing gears lifting away from another and then striking each other as a result of high frequency torque fluctuations.

Along with gear rattle, order based responses from the second or third engine order may be passed through the drivetrain and into the body structure. This sound can be greatly amplified if the components forming the sound are excited at their resonant frequencies.

Torsional vibration issues are further compounded by efforts to improve vehicle efficiency. Reductions in vehicle size and weight as well as reductions in driveline component inertia, such as flywheel masses, as well as reductions in transmission oil viscosity have added to the existing torsional vibration challenges. Lower drivetrain inertia results in a higher natural frequency of the drivetrain. As the engine rotational speed passes through the drivetrain natural frequency, resonant frequency occurs. The input displacement of a system is amplified at resonant frequency.

It is well known in the art to incorporate torsional vibration damping mechanisms in a dry clutch. As rotation occurs, the energy storage means within the damper, typically coil springs, provide the rotational compliance between the rotating elements. Another component of the damper is hysteresis, which is provided by friction producing elements. The hysteresis cooperates with the energy storage component of the damper to remove energy from the system.

The prior art is replete with mechanisms of negating or mitigating both forms of gear rattle. Such mechanisms are commonly incorporated in master clutch plates and, of late, in so called dual mass flywheels. It is also known to incorporate a mechanism in a transmission countershaft to mitigate idle rattle.

In the prior art, various types of vehicle torsional damping mechanisms which both isolate and dampen torsional vibration have been devised with limited success. For example, master clutches used in combination with manual shift mechanical transmissions have long employed torsional damping mechanisms having spring isolators and mechanical friction damper devices disposed in parallel with one another to attenuate and dampen driveline torque changes and resulting torsional vibration. One such device is disclosed in U.S. Pat. No. 4,782,932, the disclosure of which is hereby expressly incorporated by reference. In this device, a torsional damping mechanism is adapted to be disposed between the engine and the attached transmission and includes a viscous damping device in parallel with a torque transmitting torsion spring bar. Another torsional damping assembly is disclosed in U.S. Pat. No. 4,790,792, the disclosure of which is hereby expressly incorporated by reference, which discloses a device having a torsion damping assembly consisting of a spring and a viscous damper. The spring assembly is disposed in parallel to a dampening section where the spring is a torsion shaft and a plurality of circumferential grooves are used to supply viscous damping by the introduction of a viscous substance such as silicone injected between the gap formed between the grooves and a like number of engaging annular rings. Although the above mentioned devices are good vibration isolation mechanisms, they are more complicated than would be desired.

U.S. Pat. No. 4,677,868 discloses an idle rattle mechanism incorporated in a countershaft assembly of a gear-change manual transmission. The countershaft assembly includes a cluster gear having ratio gears fixed thereto, a driven or head gear journaled on the cluster gear, loosely intermeshed teeth fixed to the cluster gear and the driven gear to limit relative rotation therebetween, and a viscous liquid disposed between the teeth for damping engine idle torsional vibrations which cause idle rattle. Although this device is a good idle rattle reduction mechanism, the fact that it is located in the transmission makes the device gear ratio sensitive and is therefor not effective for isolating driveline vibrations.

It is desirous to provide a system for idle rattle abatement in a driveline having a friction torque device. It is also desirous to have an abatement in a system that employs friction torque devices found in the state of the art. It is further desirous to provide an idle rattle abatement system that may be incorporated in a current transmission.

Therefore, there is a need in the art to provide an idle rattle abatement system for a driveline that may be employed with a conventional friction torque device and gear-change transmission.

### SUMMARY OF THE INVENTION

In accordance with the present invention, a new and improved system and method for idle rattle abatement is provided in a vehicle transmission system comprising a fuel controlled engine having an output shaft, a gear change transmission having an input shaft driven by said engine and an output shaft. A controller for receiving a plurality of input signals, including (i) a first input signal indicative of the transmission engagement state, and (ii) a second input signal indicative of the rotational speed of the engine output shaft, processes the signals in accordance with logic rules to issue command output signals to system actuators for controlling a wet clutch.

The transmission engagement state corresponding to the value of said first signal is determined. The second signal corresponding to an engine output shaft rotational speed is compared to an idle state reference value. If the transmission engagement state is neutral, and if the engine output shaft rotational speed signal is less than reference value, for example at the top of the engine idle speed range, the logic to causes the torque fluctuations acting upon the transmission input shaft to be damped.

The torque fluctuations may be damped by activation of a lubrication circuit to provide lubrication to said wet clutch. Furthermore, the torque fluctuations may be damped by at least partially disengaging frictional elements of the wet clutch, as well as a combination of at least partially disengaging frictional elements of the wet clutch and activating the lubrication circuit to provide lubrication to said wet clutch.

### BRIEF DESCRIPTION OF THE DRAWINGS

FIG. 1 is a schematic illustration of an at least partially automated vehicular mechanical transmission system utilizing the control logic of the present invention.

FIG. 2 is a cross-sectional view of a wet clutch assembly revealing a wet clutch in an operating environment.

FIG. 3 is a schematic illustration, in flow chart format, of the idle rattle abatement control logic of the present invention.

### DETAILED DESCRIPTION OF THE PREFERRED EMBODIMENT

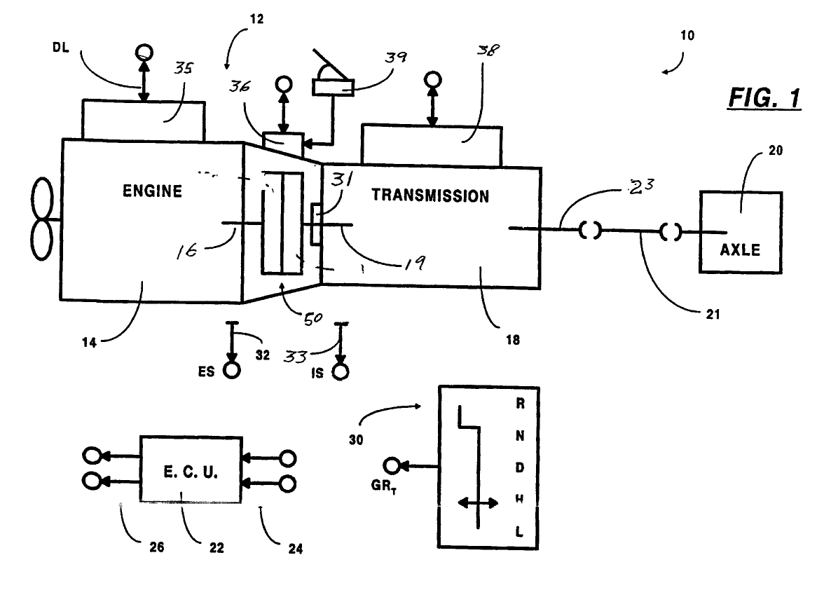

FIG. 1 illustrates a vehicle powertrain 10 including an at least partially automated mechanical transmission system 12 utilizing the idle rattle abatement control logic of the present invention. Powertrain 10 includes an internal combustion engine 14 (such as a gasoline or diesel engine), a wet clutch 50, a mechanical transmission 18, and a drive axle assembly 20 driven by propeller shaft 21.

Transmission 18 may be of a standard 5-, 6-, 7-, 9-, 10-, 12-, 18- or greater forward speed design. Examples of such transmissions may be seen by reference to U.S. Pat. Nos. 4,373,403; 4,754,665; and 5,390,561, the disclosures of which are incorporated herein by reference. Transmission 18 is coupled to wet clutch 50 by an input shaft 19. Transmission 18 provides torque to propeller shaft 21 through output shaft 23.

The automated transmission system 12 preferably will include microprocessor-based controller 22 for receiving various input signals 24 and processing same according to logic rules to issue command output signals 26 to various system actuators.

A shift selector 30 provides a signal GRS indicative of selected transmission operating mode or state, i.e. neutral, and/or of a request for an up- or downshift for a currently engaged ratio, speed sensor 32 provides a signal ES indicative of the rotational speed of the engine crank shaft 16 and speed sensor 33 provides a signal IS indicative of the rotational speed of the transmission input shaft 19.

An engine controller 35 is provided for controlling speed or torque of the engine, a clutch actuator 36 is provided for controlling operation of the wet clutch 50, and a transmission operator 38 may be provided to control shifting of the transmission. Alternatively, the clutch 50 may be utilized only for starting and stopping the vehicle and may be controlled by a manual clutch pedal 39. An upshift brake 31, preferably under control of ECU 22, also may be provided.

The ECU 22 may be separate or integral with the engine controller 35. The various controllers, sensors and/or actuators may communicate over a data bus conforming to an industry standard protocol, such as SAE J-1939 or the like. Suitable sensors and actuators are known to those of ordinary skill in the art and examples thereof, not intended to be limiting, may be seen by reference to U.S. Pat. Nos. 4,361,060; 4,873,881; 4,974,468; 5,135,218; 5,279,172; 5,305,240; 5,323,669; 5,408,898; 5,441,137, 5,445,126; 5,448,483 and 5,481,170.

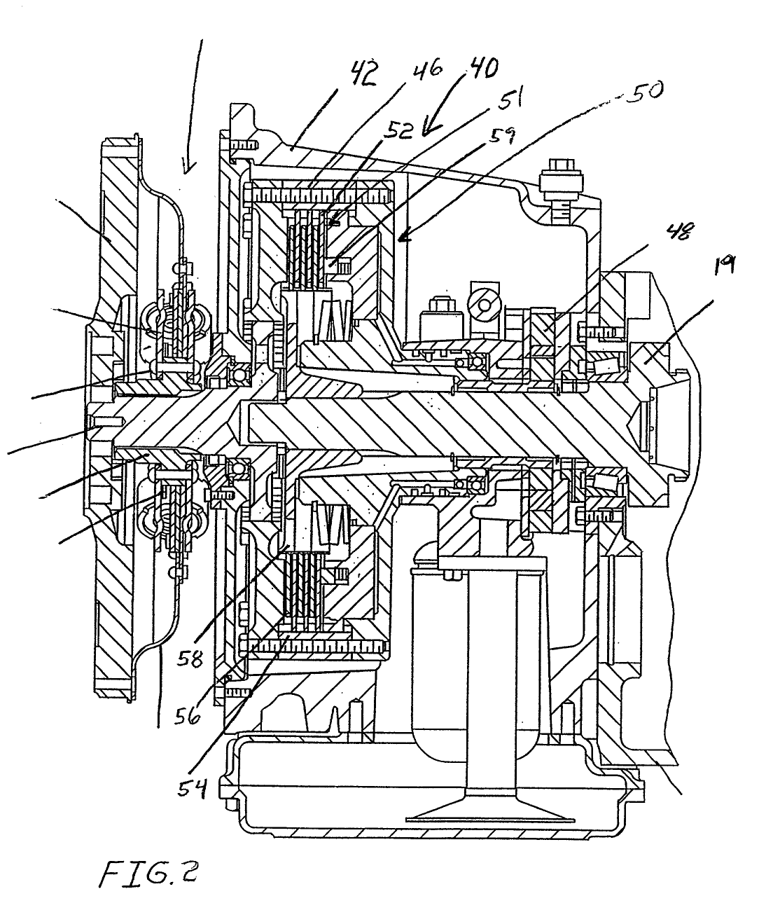

FIG. 2 is a cross sectional view of a wet clutch assembly 40 revealing a wet clutch 50 in an operating environment. Wet clutch assembly 40 comprises a housing 42 which is sealed to prevent oil from leaking from the wet clutch assembly 40. A clutch pack 51, comprising interposed stationary clutch plates 52 and rotating clutch plates 56 is engaged by engaging actuation ring 59 against the clutch pack 51, causing the stationary clutch plates 52 to contact the rotating clutch plates 56 to achieve frictional engagement. Oil pressure is provided to the wet clutch 50 by a pump 48, which in the present embodiment is a gerotor pump.

The stationary clutch plates 52 are splined to a clutch pack housing 54. The rotating clutch plates 56 are splined to a hub 58. In the preferred embodiment, hub 58 is internally splined to receive transmission input shaft 19.

The ECU 22 receives a plurality of input signals 24, including a first input signal GRS which is indicative of a transmission engagement state, and a second input signal ES which is indicative of the rotational speed of the engine output shaft 16. It should be noted that although specific sensors are identified herein, that any suitable sensor may be substituted for those identified. ECU 22 will determine the transmission engagement state corresponding to the value of the first signal GRS. If the ECU 22 determines that the transmission engagement state is NEUTRAL then the ECU 22 will compare the second signal ES, corresponding to an engine output shaft rotational speed, to an idle state reference value. The idle state reference value is indicative of an engine RPM for a maximum idle speed. The ECU 22 compares the second signal ES to the idle state reference value and if ES is less than the idle state reference value the logic rules within ECU 22 will issue command output signals 26 to system actuators causing torque fluctuations acting upon a transmission input shaft 19 to be damped.

For example, output signals 26 may activate a lubrication circuit (not shown) to provide lubrication to the wet clutch 50. Those skilled in the art will immediately recognize that the addition of lubrication to wet clutch 50 will cause viscous drag, thereby damping torque fluctuations which may otherwise act upon the transmission input shaft 19.

Alternatively, the output signals 26 may command the wet clutch 50 to engage, partially engage, partially disengage, or fully disengage. Partial or full engagement or disengagement may be achieved by control of the actuation ring 59. It should be understood to be within the scope of the present invention that a combination of clutch engagement, disengagement, partial engagement, partial disengagement and activation of a lubrication circuit may be employed to dampen input shaft 19 torsional vibrations. Activation of lubrication circuit and actuation of the wet clutch 50 may be achieved with predetermined set values or with a feedback control loop.

Furthermore, signal IS indicating transmission input shaft speed may be filtered by any appropriate filtering algorithm known in the art, including an FFT, to determine whether input shaft rattle is present. As such, signal IS may be provided to ECU 22 for processing in accordance with logic rules to issue command output signals 26 to damp torque fluctuations acting upon the transmission input shaft 19. Signal IS may be conditioned by ECU 22 to apply logic rules based on threshold values of frequency amplitude at a specific frequency, frequency amplitude within a band of frequencies, vibrational mode or and vibrational order.

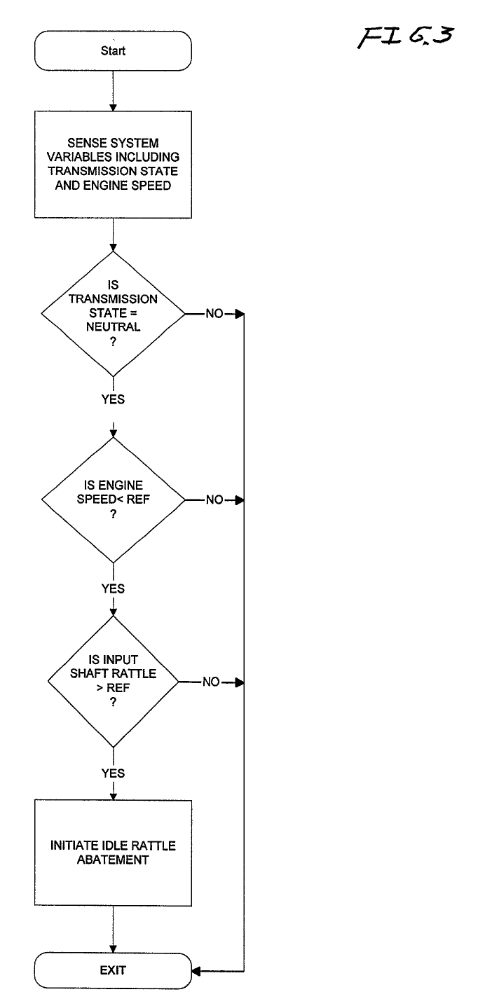

FIG. 3 is a flow chart representation of the shift logic modification of the present invention.

Accordingly, it may be seen that a new and improved control system/method for upshifting has been provided.

The foregoing discussions discloses and describes the preferred embodiment of the present invention. However, one skilled in the art would readily recognize from the discussion and the accompanying drawings and claims that various changes, modifications and variations can be made therein without departing from the true spirit and fair scope of the invention as defined in the following claims.

I claim:

1. A method for reducing gear rattle in a vehicle transmission system comprising a fuel controlled engine having an output shaft, a gear change transmission having an input shaft driven by said engine and an output shaft, a controller for receiving a plurality of input signals including (i) a first input signal indicative of the transmission engagement state, and (ii) a second input signal indicative of the rotational speed of the engine output shaft, said processor for processing said signals in accordance with logic rules to issue command output signals to system actuators for controlling a wet clutch, said method comprising:
determining a transmission engagement state corresponding to the value of said first signal;
comparing said second signal corresponding to an engine output shaft rotational speed to an idle state reference value; and
if said transmission engagement state indicates neutral, and if engine output shaft rotational speed signal is less than said idle state reference value, causing said logic to dampen torque fluctuations acting upon the transmission input shaft.

2. The method of claim 1, wherein the torque fluctuations are damped by activation of a lubrication circuit to provide lubrication to said wet clutch.

3. The method of claim 1, wherein the torque fluctuations are damped by at least partially disengaging frictional elements of the wet clutch.

4. The method of claim 3, wherein torque fluctuations are also damped by activation of a lubrication circuit to provide lubrication to said wet clutch.
